(19) United States
(12) Patent Application Publication
(10) Pub. No.: US 2025/0209651 A1
(43) Pub. Date: Jun. 26, 2025

(54) METHODS, SYSTEMS AND COMPUTER PROGRAMS FOR RELATIVE DEPTH MAP IMAGE GENERATION

(71) Applicant: MAXAR INTERNATIONAL SWEDEN AB, Linköping (SE)

(72) Inventors: Tim Yngesjö, Linköping (SE); Sanna Ringqvist, Linköping (SE); Simon Wold, Linköping (SE); Simon Sandin, Karlstad (SE)

(21) Appl. No.: 18/983,005

(22) Filed: Dec. 16, 2024

(30) Foreign Application Priority Data
Dec. 22, 2023 (SE) 2351501-8

(51) Int. Cl. G06T 7/55; G06T 17/05; G06V 20/10

(52) U.S. Cl. CPC G06T 7/55; G06T 17/05; G06V 20/10; G06T 2207/10028; G06T 2207/10041; G06T 2207/10044; G06T 2207/20081; G06T 2207/20084; G06T 2207/30184; G06T 2207/30188

(57) ABSTRACT

The present disclosure relates to a method for generating a relative depth map image. The method comprises feeding at least two input images to a neural network, the input images relating to a region of interest at different time periods, the input images being obtained at corresponding arbitrary positions and attitudes with respect to the region of interest, and predicting, using the neural network, the relative depth map image.

### CROSS-REFERENCE TO RELATED APPLICATION

This application claims the benefit of, and priority to, Swedish Patent Application No. 2351501-8, filed Dec. 22, 2023. The entire disclosure of the above application is incorporated herein by reference.

### FIELD

The present disclosure relates to methods, systems and computer programs for training a neural network to generate a relative depth map image and methods, systems and computer programs for generating a relative depth map image.

### BACKGROUND

This section provides background information related to the present disclosure which is not necessarily prior art.

Surveillance of urban development, agriculture, landscapes and forests often involves the need to detect and accurately quantify changes. One important tool for observing a current state of a region of interest is depth maps. In particular, changes in depth maps may correlate with important changes in the surveillance objective, such as an increase in height due to a new building being erected or a forest or crop field being harvested. There is thus a need in the art for fast, accurate and flexible ways of characterising changes in depth maps.

### SUMMARY

This section provides a general summary of the disclosure, and is not a comprehensive disclosure of its full scope or all of its features. Aspects and embodiments of the disclosure are set out in the accompanying claims.

It is an objective of the present disclosure to provide methods, systems and computer programs that computationally efficient and flexible ways to detect and accurately quantify depth changes in a region of interest.

A depth map, as used herein, is a representation of the distances of a set of points with respect to a plane. The points may be projected in three ways: orthographic, oblique and perspective. In orthographic projection, the set of points are projected onto the plane along a normal direction of the plane and the respective distances are calculated based on the difference between respective actual point positions and the corresponding projected positions. In oblique projection, the set of points are projected along a direction different from a normal direction of the plane and the respective distances are calculated based on the difference between respective actual point positions and the corresponding projected positions. In perspective projection, rays are traced between the set of points and a reference point, often called the centre of projection, and the points are projected onto the plane where the respective rays intersect with the plane. The respective distances are then calculated based on the difference between respective actual point positions and the corresponding projected positions.

A depth map image, as used herein, is a depth map that is represented as pixel data. A relative depth map image is an image that is generated based on a difference between two depth map images. In one embodiment, the difference is determined by the L1-norm, also known as the Manhattan distance, between corresponding pixels. The values of the relative depth map image pixels can in some embodiments be weighted, e.g. to scale the values to fall within a desired interval. A depth change is a difference between two depth map images, each relating to a depth of a region of interest when observed at a certain attitude and position with respect to the region of interest, wherein the two depth map images represent said depths at different times.

The present disclosure relates to a method for training a neural network to generate a relative depth map image. The method comprises obtaining a first set of images relating to a region of interest within a first time period. The method further comprises obtaining a second set of images relating to the region of interest within a second time period. The method also comprises generating a first depth map image based on the first set of images, the first depth map image relating to a depth of the region of interest when observed at a certain attitude and position with respect to the region of interest. The method additionally comprises generating a second depth map image based on the second set of images, the second depth map image relating to a depth of the region of interest when observed at the corresponding attitude and position with respect to the region of interest as the first depth map image. The method further comprises generating a first relative depth map image based on a difference between the first depth map image and the second depth map image. The method also comprises generating, using a neural network, a second relative depth map image, based on a first input image comprising at least one of: the first depth map image, an image of the first set of images, an image generated from a 3D-model of the region of interest at the first time period, and a second input image comprising at least one of: an image of the second set of images, an image generated from a 3D-model of the region of interest at the second time period, wherein the first input image and the second input image have the corresponding attitude and position with respect to the region of interest. The method additionally comprises changing parameters of the neural network based on a difference between the second relative depth map image and the first relative depth map image.

The disclosed method thereby enables learning prediction of depth change in a new satellite image compared to an older, existing satellite image or 3D-model of the region of interest at the old time period. As used herein, “3D-model” refers to a digital 3D-model, e.g., a software based rendering of the thing being modeled.

According to some aspects, generating the first depth map image further comprises generating a first 3D-model of the region of interest at the first time period based on the first set of images, and wherein the generating the first depth map image is further based on the first 3D-model. According to some aspects, generating the second depth map image further comprises generating a second 3D-model of the region of interest at the second time period based on the second set of images, and wherein generating the second depth map image is further based on the second 3D-model.

In embodiments, a technical effect and/or advantage of the methods and systems of the disclosure is that generating 3D-models enables augmenting the training process of the neural network with synthetic data by rendering the region of interest from different perspectives and locations of the virtual camera and/or generating corresponding depth map images. A further technical effect and advantage is that a virtual camera can generate images matching at the corresponding attitude and position with respect to the region of interest as those of a set of captured images. This is very useful if images captured during two different time periods do not match, as renders from the 3D model can overcome this problem.

According to some aspects, the first and second set of images relating to the region of interest comprise satellite images and/or panchromatic images and/or synthetic aperture radar, SAR, images and/or aerial images. Satellite images may comprise additional data, e.g. in the form of latitude and longitude of the satellites, which facilitates image registration. According to some aspects, the additional data comprises sensor angle. According to some aspects, the additional data comprises time and date of the image capture. Panchromatic images enable higher resolution imagery without the need for larger, more expensive lenses and imagers for each multispectral band.

The present disclosure also relates to a method for generating a relative depth map image. The method comprises obtaining a first input image relating to a region of interest observed at a first time period and at a specific attitude and position relative to the region of interest. The first input image comprises one of: a first depth map image of the region of interest when observed at said attitude, position and first time period, an image of the region of interest when observed at said attitude, position and first time period, an image generated from a 3D-model of the region of interest at the first time period, the image generated from the 3D-model being generated at said attitude and position with respect to the region of interest. The method further comprises obtaining a second input image relating to the region of interest observed at a second time period and at the corresponding attitude and position relative to the region of interest as for the first input image. The second input image comprises one of: an image of the region of interest when observed at said attitude, position and second time period, an image generated from a 3D-model of the region of interest at the second time period, the image generated from the 3D-model being generated at said attitude and position with respect to the region of interest. The method also comprises generating, using a neural network, the relative depth map image, based on the obtained first and second input images.

The disclosed method thereby enables prediction of depth change in a new satellite image compared to an older, existing satellite image or 3D-model of the region of interest at the old time period.

According to some aspects, the method further comprises generating a second depth map image based on the first depth map image and the generated relative depth image.

This provides updated depth map images.

According to some aspects, the method further comprises detecting if the generated relative depth image meets a predetermined criterion relating to a measure of change of relative depth.

The method can thereby indicate contextually relevant topological changes, which may be used to e.g. update a 3D-model of the region and/or form the basis of a map layer for topographical maps.

According to some aspects, the method further comprises determining a volumetric change based on a plurality of generated relative depth images of the region of interest at different respective attitudes and positions with respect to the region of interest.

By determining the volumetric change, corresponding mass displacements can be estimated, such as amount of melted snow and ice. The volumetric change can also be used to estimate changes in (dense) vegetation, e.g. due to forest fires or deforestation. The volumetric change may be used to estimate resources needed to address issues associated with the volumetric change, such as transportation needs to remove the mass associated with the volumetric change, or drainage needs and/or rescue needs in case of flooding.

According to some aspects, the method further comprises determining characteristics of zones in the generated relative depth image, wherein the characteristics of a zone comprise at least one of: identification of a zone comprising an infrastructure project, identification of a zone with a completed or non-completed building construction and/or building tear-down, identification of a zone being an agricultural field from identification of seasonal changes, identification of a zone of deforestation, identification of a zone comprising melting ice, such as a glacier, identification of a zone comprising a land slide, identification of a zone affected by an earth quake, identification of a zone affected by fire, identification of a zone affected by flooding, identification of a zone comprising at least one vehicle.

This enables surveillance of the associated activities.

According to some aspects, the method further comprises determining if a predetermined trigger level for triggering reconstruction of a 3D-model of the region of interest is exceeded based on at least one generated relative depth image.

This eliminates unnecessary work relating to reconstruction of the 3D-model.

According to some aspects, the first and/or second input image comprise satellite images and/or panchromatic images and/or synthetic aperture radar, SAR, images.

Satellite images may comprise additional data in the form of latitude and longitude of the satellites, which facilitates image registration. Panchromatic images enable higher resolution imagery without the need for larger, more expensive lenses and imagers for each multispectral band.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 illustrates aspects of the disclosed method for training a neural network to generate a relative depth map image;

FIG. 2 illustrates aspects of the disclosed method for generating a relative depth map image; and

FIG. 3 illustrates aspects of the disclosed system for generating a relative depth map image.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

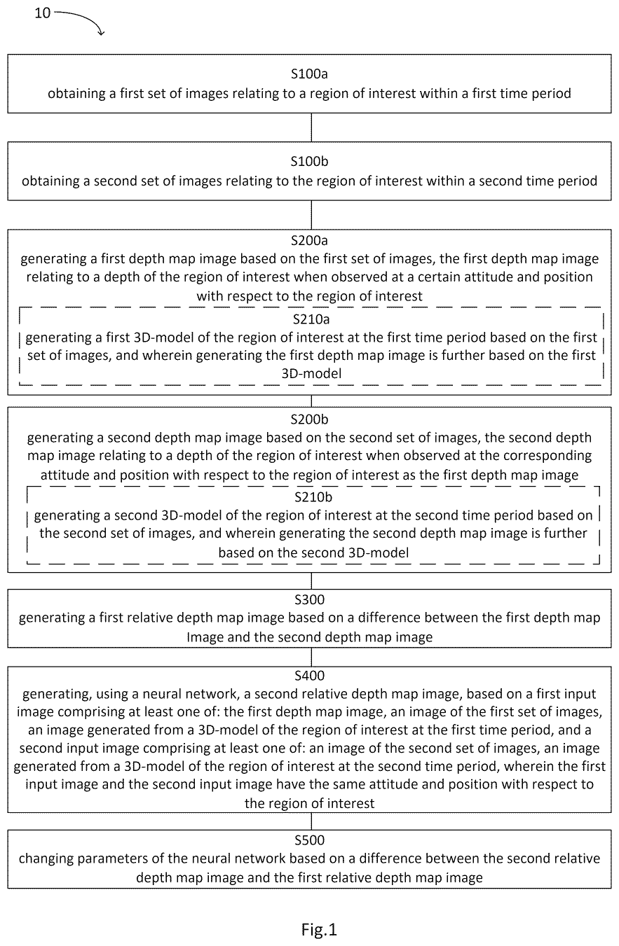

FIG. 1 illustrates aspects of the disclosed method 10 for training a neural network to generate a relative depth map image.

Artificial neural networks, herein simply referred to as neural networks, are so-called universal function approximators, which means that (sufficiently large) neural networks can approximate any input-output mapping function. Neural networks typically comprise a set of modules configured to perform mathematical functions, such as performing a convolution or performing a non-linear mapping. The particular set of modules and the way they are connected to each other, which dictates how information flows, is often referred to the architecture of the neural network. Some of the modules comprise parameters that dictate the exact effect the module will have. For instance, a module configured to perform a convolution operation will depend on the parameters of a convolution kernel. For traditional reasons, parameters are sometimes referred to as weights and biases. The effect of the neural network, i.e. the resulting inference of the neural network given a specific input, will depend on both the architecture and the parameters.

Training of neural networks in some instances may require changing at least some of the parameters to have the inferences of the neural network approach a desired output. However, there are methods that also change the architecture during training, e.g. by removing portions of the network that are used very little, or add and/or change modules performing non-linear mappings, that have the inferences of the neural network approach a desired output.

Training of neural networks using so-called supervised learning typically comprises three general activities. First, a data set typically comprising pairs of representative input and desired output is obtained. The obtained data set is often divided into two sets-a training set and a validation set. The training set comprises pairs of representative input and desired output that will be used to update the parameters of the neural network to gradually improve the ability of the neural network to infer the desired output given a corresponding representative input. The validation set is used to test progress of the training by comparing what the neural network infers from validation set representative input to corresponding validation set desired output. In other words, the data from the validation set is not used to update the parameters of the neural network; it is only used to gauge how well the neural network is currently performing.

Second, representative input from the training set is used as input to the neural network. The neural network performs an inference, i.e. generates an output, based on the representative input. The output from the neural network will depend on the architecture and the parameters of the network at the time of inference.

Third, the output from the neural network is compared to the desired output to the corresponding representative input and parameters of the neural network are changed based on the comparison. The comparison depends on the task of the neural network. The comparison is typically performed by means of a so-called loss function. If the task is classification, a common loss function is binary cross entropy loss, wherein the neural network predicts a classification and compares the classification to the corresponding desired output using binary cross entropy as a measure of how well the neural network currently performs. If the task is image-to-image translation, common loss functions include distance-based losses, such as L1 (Manhattan distance) and L2 (least-square distance), as well as earth mover distance. Several loss functions can be combined into a single loss function, e.g. by performing a weighted sum of calculated losses. When the comparison has been made and a loss, i.e. a measure of how well the neural network is currently performing, has been established, the parameters of the network are updated based on the calculated loss. The update is typically performed based on back-propagation, wherein the chain rule is used to propagate error correcting parameter adjustments throughout the network.

Following the brief outline of how supervised learning of a neural network is performed, the corresponding aspects of the disclosed method 10 for training a neural network to generate a relative depth map image follows below, starting with the obtaining of data that may be used for training and/or validation of the neural network.

The method comprises obtaining S100a a first set of images relating to a region of interest within a first time period. The method further comprises obtaining S100b a second set of images relating to the region of interest within a second time period. According to some aspects, the first and second set of images relating to the region of interest comprise satellite images and/or panchromatic images and/or synthetic aperture radar, SAR, images.

In order to effectively train the neural network and obtain the ability of the neural network to be able to be used with input relating to arbitrary positions and attitudes with respect to the region of interest, in some embodiments it will be necessary to train the neural network with training data comprising images obtained at different attitudes and/or positions with respect to the region of interest.

Thus, according to some aspects, the first set of images comprises at least two images obtained at different attitudes and/or positions with respect to the region of interest. According to some aspects, the second set of images comprises at least two images obtained at different attitudes and/or positions with respect to the region of interest.

The method also comprises generating S200a a first depth map image based on the first set of images, the first depth map image relating to a depth of the region of interest when observed at a certain attitude and position with respect to the region of interest. The method additionally comprises generating S200b a second depth map image based on the second set of images, the second depth map image relating to a depth of the region of interest when observed at the corresponding attitude and position with respect to the region of interest as the first depth map image.

In one embodiment, the region of interest is observed at identical attitudes and positions when capturing corresponding images in the first and second set of images, from which corresponding first and second depth map images may be generated, but in practice this can be difficult or rare to achieve. The word corresponding, when used with respect to attitude and position, will throughout the present disclosure mean as similar as possible, reflecting measurement inaccuracies, such as images captured at slightly different positions and/or attitudes. The disclosed methods described above and below will work even if the first and second depth map images are not observed at identical attitudes and positions, but the accuracy of the generated relative depth map images will depend on how well the attitudes and positions match.

According to some aspects, generating S200a a first depth map image comprises generating at least two first depth map images, the at least two first depth map images relating to a depth of the region of interest when observed at different certain attitudes and/or positions with respect to the region of interest. According to some further aspects, generating S200b a second depth map image comprises generating at least two second depth map images, the at least two first depth map images relating to a depth of the region of interest when observed at respective corresponding attitude and position with respect to the region of interest as the at least two first depth map images.

According to some aspects, a respective 3D-model is first constructed based on the first and/or second set of images relating to the region of interest. The 3D-models may be generated based on structure from motion and/or simultaneous localization and mapping. According to some aspects, the respective 3D-models are generated based on photogrammetry, wherein mono-images, i.e. single images taken from a camera, are taken during the respective first and/or second time period, and from which virtual stereo pairs of images are determined based on corresponding features in the images. In other words, the 3D-models may be generated based on stereo pairs of images from only real images, stereo pairs of images from virtual images and/or stereo pairs of images comprising both real and virtual images. According to some aspects, at least one pair of the real images are captured as a stereo pair. This enables a large set of images, e.g. tens to hundreds of images, to be paired up and used to refine the accuracy of the respective 3D-models, both with respect to 3D-mesh generation and associated textured. The 3D-models may comprise a 3D-mesh with associated textures. According to some aspects, at least one 3D-model comprises a neural radiance field configured to enable renders of the region of interest from arbitrary viewpoints. According to some aspects, at least one 3D-model comprises plenoxel data configured to enable renders of the region of interest viewed at arbitrary positions and attitudes. According to some aspects, the 3D-model comprises a 3D-gaussian splat model configured to enable renders of the region of interest viewed at arbitrary positions and attitudes. A 3D-model enables the generation of highly detailed and accurate depth map images and/or synthetic images, i.e. images captured with a virtual camera in order to simulate a corresponding image captured with a corresponding real camera, from arbitrary attitudes and positions with respect to the region of interest. Synthetic images enable augmenting the training of the neural network with synthetic data and enables improved matching of position and attitudes of the viewpoints at which the region of interest is observed and for which relative depth images are generated.

Thus, according to some aspects, generating S200a the first depth map image further comprises generating S210a a first 3D-model of the region of interest at the first time period based on the first set of images, and wherein the generating S200a the first depth map image is further based on the first 3D-model.

According to some aspects, generating S200b the second depth map image further comprises generating S210b a second 3D-model of the region of interest at the second time period based on the second set of images, and wherein generating S200b the second depth map image is further based on the second 3D-model.

A relative depth map image that can function as ground truth relative depth map image, i.e. the desired output of a neural network, can then be generated from the first and second depth map images.

Thus, the method further comprises generating S300 a first relative depth map image based on a difference between the first depth map image and the second depth map image.

By generating S300 the first relative depth map image, the desired output part of the representative input and desired output pairing has been made.

If, as described above, at least two first and at least two second depth map images have been generated, at least two first relative depth map images can then be created, wherein the at least two first relative depth map images relate to observing the region of interest at different attitudes and/or positions.

Thus, according to some aspects, generating the first relative depth map image comprises generating at least two first depth map images based on respective differences between corresponding at least two first depth map images and at least two second depth map images.

The representative input is preferably chosen based on how the neural network is intended to be used operationally. The representative input will comprise at least a first input image and a second input image.

The first input image comprises at least one of: the first depth map image, an image of the first set of images, an image generated from a 3D-model of the region of interest at the first time period.

The second image comprises at least one of: an image of the second set of images, an image generated from a 3D-model of the region of interest at the second time period.

The first input image and the second input image have the corresponding attitude and position with respect to the region of interest.

Thus, there is a representative input in the form of the first and second input image and a corresponding desired output in the form of the first relative depth map image. By repeating these activities several times, for different attitudes and/or positions with respect to the region of interest, a data set of representative input and desired output pairings can be generated, from which we can select a training set and optionally a validation set.

With training data generated, the neural network can perform an inference and its parameters can be updated based on a comparison between the output from the neural network and the desired output.

Thus, the method also comprises generating S400, using the neural network, a second relative depth map image, based on a first input image comprising at least one of: the first depth map image, an image of the first set of images, an image generated from a 3D-model of the region of interest at the first time period, and a second input image comprising at least one of: an image of the second set of images, an image generated from a 3D-model of the region of interest at the second time period, wherein the first input image and the second input image have the corresponding attitude and position with respect to the region of interest.

According to some aspects, the activity of generating S400 the second relative depth map image comprises generating S400, using the neural network, at least two second relative depth map images, based on corresponding at least two first input image, each first input image comprising at least one of: the first depth map image, an image of the first set of images, an image generated from a 3D-model of the region of interest at the first time period, and at least two second input images, each second input image comprising at least one of: an image of the second set of images, an image generated from a 3D-model of the region of interest at the second time period, wherein each first input image and the second input image have the corresponding attitude and position with respect to the region of interest.

The method additionally comprises changing S500 parameters of the neural network based on a difference between the second relative depth map image and the first relative depth map image. According to some further aspects, the activity of changing S500 parameters of the neural network is further based on respective differences between at least two second relative depth map images and corresponding first relative depth map images.

A technical effect, and corresponding advantage, of performing the activities of the method is a neural network that can generate relative depth map images of a region of interest when observed from an arbitrary position an attitude with respect to the region of interest.

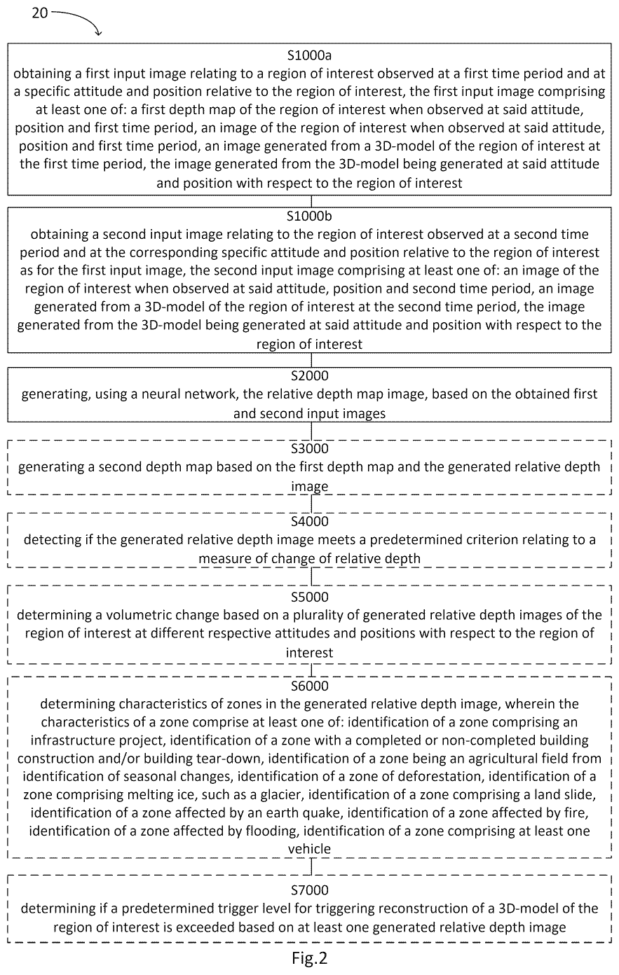

FIG. 2 illustrates aspects of the disclosed method 20 for generating a relative depth map image.

The method 20 comprises obtaining S1000a a first input image relating to a region of interest observed at a first time period and at a specific attitude and position relative to the region of interest. The first input image comprises at least one of: a first depth map image of the region of interest when observed at said attitude, position and first time period, an image of the region of interest when observed at said attitude, position and first time period, an image generated from a 3D-model of the region of interest at the first time period, the image generated from the 3D-model being generated at said attitude and position with respect to the region of interest.

The method 20 further comprises obtaining S1000b a second input image relating to the region of interest observed at a second time period and at the corresponding attitude and position relative to the region of interest as for the first input image. The second input image comprises at least one of: an image of the region of interest when observed at said attitude, position and second time period, an image generated from a 3D-model of the region of interest at the second time period, the image generated from the 3D-model being generated at said attitude and position with respect to the region of interest. The first and/or second input images can be obtained as described in relation to FIG. 1, above.

According to some aspects, the first and/or second input image comprise satellite images and/or panchromatic images and/or synthetic aperture radar, SAR, images.

The method 20 additionally comprises generating S2000, using a neural network, the relative depth map image, based on the obtained first and second input images.

According to some aspects, the neural network is a neural network trained as described in relation to FIG. 1 above. The neural network may also be configured by other methods as long as the neural network is configured to perform the above-mentioned activities of obtaining S1000a, S1000b a first and second input image and generating S2000 the relative depth map image based on the obtained first and second input images.

With the relative depth map image generated, a number of further applications are possible.

For instance, existing depth map images can be updated based on the generated relative depth map image. Thus, according to some aspects, the method 20 further comprises generating S3000 a second depth map image based on the first depth map image and the generated S2000 relative depth image.

The generated S2000 relative depth image can be used indicate regions of interest or trigger downstream activities. Thus, according to some aspects, the method 20 further comprises detecting S4000 if the generated S2000 relative depth image meets a predetermined criterion relating to a measure of change of relative depth. For example, according to some aspects, the method further comprises determining S7000 if a predetermined trigger level for triggering reconstruction of a 3D-model of the region of interest is exceeded based on at least one generated S2000 relative depth image.

Events such as landslides, building collapses or melted snow and ice can be associated with large volumetric displacements and/or the need to displace large volumes. In such scenarios, it is therefore advantageous to be able to estimate the volumetric change in order to assess what measures need to be taken and/or what resources are needed to take said measures. Thus, according to some aspects, the method 20 further comprises determining S5000 a volumetric change based on a plurality of generated S2000 relative depth images of the region of interest at different respective attitudes and positions with respect to the region of interest.

The relative depth image can also be used for surveillance purposes by monitoring changes in depth associated with the surveillance objective. Thus, according to some aspects, the method further comprises determining S6000 characteristics of zones in the generated S2000 relative depth image, wherein the characteristics of a zone comprise at least one of: identification of a zone comprising an infrastructure project, identification of a zone with a completed or non-completed building construction and/or building tear-down, identification of a zone being an agricultural field from identification of seasonal changes, identification of a zone of deforestation, identification of a zone comprising melting ice, such as a glacier, identification of a zone comprising a land slide, identification of a zone affected by an earth quake, identification of a zone affected by fire, identification of a zone affected by flooding, identification of a zone comprising at least one vehicle. The at least one vehicle may be any kind of vehicle that can be resolved by the change in depth, such as airplanes, trains, boats, cars, military vehicles.

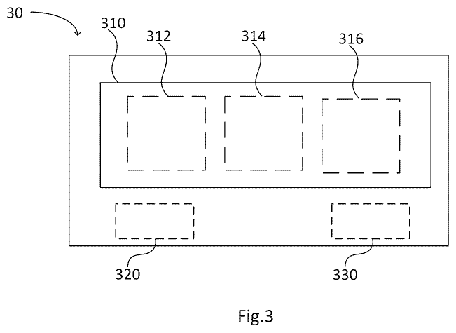

FIG. 3 illustrates aspects of the disclosed system 30 for generating a relative depth map image. The system 30 comprises processing circuitry 310 configured to obtain a first input image relating to a region of interest observed at a first time period and at a specific attitude and position relative to the region of interest, the first input image comprising at least one of: a first depth map image of the region of interest when observed at said attitude, position and first time period, an image of the region of interest when observed at said attitude, position and first time period, an image generated from a 3D-model of the region of interest at the first time period, the image generated from the 3D-model being generated at said attitude and position with respect to the region of interest. The processing circuitry 310 is further configured to obtain a second input image relating to the region of interest observed at a second time period and at the corresponding attitude and position relative to the region of interest as for the first input image, the second input image comprising at least one of: an image of the region of interest when observed at said attitude, position and second time period, an image generated from a 3D-model of the region of interest at the second time period, the image generated from the 3D-model being generated at said attitude and position with respect to the region of interest. The processing circuitry 310 is also configured to generate, using a neural network 316, the relative depth map image, based on the obtained first and second input images.

According to some aspects, the processing circuitry 310 comprises a processor 312 and a memory 314, wherein the memory 314 comprises instructions executable by said processor 312.

The images may be obtained either by the system itself and/or provided to the system.

According to some aspects, the system 30 comprises a camera system 320 configured to capture images of a region of interest. According to some further aspects, the camera system 320 is configured to capture the images at a plurality of attitudes and/or positions with respect to the region of interest. The captured images can either serve as first and/or second input images or be further processed by the system 30 to generate the necessary first and/or second input images, as described in relation to FIG. 1, above.

According to some aspects, the system 30 comprises an interface 330 configured to receive the first and/or second input image.

According to some aspects, the system 30 is further configured to update the parameters of the neural network as described in relation to FIG. 1, above. According to some aspects, the system 30 is configured to enable the neural network to receive changes to its architecture and/or parameters via the interface 330.

The present disclosure also relates to a computer program comprising computer program code for executing the method 10 for training a neural network to generate a relative depth map image as described in relation to FIG. 1 above.

The present disclosure also relates to a computer program product comprising a program code stored on a computer readable media for executing the method 10 for training a neural network to generate a relative depth map image as described in relation to FIG. 1 above.

The present disclosure also relates to a computer program comprising computer program code for executing the method 20 for generating a relative depth map image as described in relation to FIG. 2 above.

The present disclosure also relates to a computer program product comprising a program code stored on a computer readable media for executing the method 20 for generating a relative depth map image as described in relation to FIG. 2 above.

A computer, controller, network or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the embodiments described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, and as described, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112 (f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### EXAMPLE EMBODIMENTS

Additional example embodiments are provided below.

Embodiment 1. A method (10) for training a neural network to generate a relative depth map image, the method comprising: obtaining (S100a) a first set of images relating to a region of interest within a first time period; obtaining (S100b) a second set of images relating to the region of interest within a second time period; generating (S200a) a first depth map image based on the first set of images, the first depth map image relating to a depth of the region of interest when observed at a certain attitude and position with respect to the region of interest; generating (S200b) a second depth map image based on the second set of images, the second depth map image relating to a depth of the region of interest when observed at the corresponding attitude and position with respect to the region of interest as the first depth map image; generating (S300) a first relative depth map image based on a difference between the first depth map image and the second depth map image; generating (S400), using the neural network, a second relative depth map image, based on a first input image comprising at least one of: the first depth map image, an image of the first set of images, an image generated from a 3D-model of the region of interest at the first time period, and a second input image comprising at least one of: an image of the second set of images, an image generated from a 3D-model of the region of interest at the second time period, wherein the first input image and the second input image have the corresponding attitude and position with respect to the region of interest; and changing (S500) parameters of the neural network based on a difference between the second relative depth map image and the first relative depth map image.

Embodiment 2. The method (10) according to Embodiment 1, generating (S200a) the first depth map image further comprises: generating (S210a) a first 3D-model of the region of interest at the first time period based on the first set of images, and wherein generating (S200a) the first depth map image is further based on the first 3D-model.

Embodiment 3. The method (10) according to Embodiments 1 or 2, wherein generating (S200b) the second depth map image further comprises: generating (S210b) a second 3D-model of the region of interest at the second time period based on the second set of images, and wherein generating (S200b) the second depth map image is further based on the second 3D-model.

Embodiment 4. The method (10) according to any of the preceding Embodiments, wherein the first and second set of images relating to the region of interest comprise satellite images and/or panchromatic images and/or synthetic aperture radar, SAR, images and/or aerial images.

Embodiment 5. A method (20) for generating a relative depth map image, the method comprising: obtaining (S1000a) a first input image relating to a region of interest observed at a first time period and at a specific attitude and position relative to the region of interest, the first input image comprising at least one of: a first depth map image of the region of interest when observed at said attitude, position and first time period, an image of the region of interest when observed at said attitude, position and first time period, an image generated from a 3D-model of the region of interest at the first time period, the image generated from the 3D-model being generated at said attitude and position with respect to the region of interest; obtaining (S1000b) a second input image relating to the region of interest observed at a second time period and at the corresponding attitude and position relative to the region of interest as for the first input image, the second input image comprising at least one of: an image of the region of interest when observed at said attitude, position and second time period, an image generated from a 3D-model of the region of interest at the second time period, the image generated from the 3D-model being generated at said attitude and position with respect to the region of interest; and generating (S2000), using a neural network, the relative depth map image, based on the obtained first and second input images.

Embodiment 6. The method (20) according to Embodiment 5, the method further comprising: generating (S3000) a second depth map image based on the first depth map image and the generated (S2000) relative depth image.

Embodiment 7. The method (20) according to Embodiments 5 or 6, the method further comprising: detecting (S4000) if the generated (S2000) relative depth image meets a predetermined criterion relating to a measure of change of relative depth.

Embodiment 8. The method (20) according to any of Embodiments 5-7, the method further comprising: determining (S5000) a volumetric change based on a plurality of generated (S2000) relative depth images of the region of interest at different respective attitudes and positions with respect to the region of interest.

Embodiment 9. The method (20) according to any of Embodiments 5-8, the method further comprising: determining (S6000) characteristics of zones in the generated (S2000) relative depth image, wherein the characteristics of a zone comprise at least one of: identification of a zone comprising an infrastructure project, identification of a zone with a completed or non-completed building construction and/or building tear-down, identification of a zone being an agricultural field from identification of seasonal changes, identification of a zone of deforestation, identification of a zone comprising melting ice, such as a glacier, identification of a zone comprising a land slide, identification of a zone affected by an earth quake, identification of a zone affected by fire, identification of a zone affected by flooding, identification of a zone comprising at least one vehicle.

Embodiment 10. The method (20) according to any of Embodiments 5-9, the method further comprising: determining (S7000) if a predetermined trigger level for triggering reconstruction of a 3D-model of the region of interest is exceeded based on at least one generated (S2000) relative depth image.

Embodiment 11. The method (20) according to any of Embodiments 5-10, wherein the first and/or second input image comprise satellite images and/or panchromatic images and/or synthetic aperture radar, SAR, images and/or aerial images.

Embodiment 12. A system (30) for generating a relative depth map image, the system comprising processing circuitry (310) configured to: obtain a first input image relating to a region of interest observed at a first time period and at a specific attitude and position relative to the region of interest, the first input image comprising at least one of: a first depth map image of the region of interest when observed at said attitude, position and first time period, an image of the region of interest when observed at said attitude, position and first time period, an image generated from a 3D-model of the region of interest at the first time period, the image generated from the 3D-model being generated at said attitude and position with respect to the region of interest; obtain a second input image relating to the region of interest observed at a second time period and at the corresponding attitude and position relative to the region of interest as for the first input image, the second input image comprising at least one of: an image of the region of interest when observed at said attitude, position and second time period, an image generated from a 3D-model of the region of interest at the second time period, the image generated from the 3D-model being generated at said attitude and position with respect to the region of interest; and generate, using a neural network (316), the relative depth map image, based on the obtained first and second input images.

Embodiment 13. The system (30) according to Embodiment 12, wherein the processing circuitry (310) comprises a processor (312) and a memory (314), wherein the memory comprises instructions executable by said processor.

Embodiment 14. A computer program comprising computer program code for executing the method (10) for training a neural network to generate a relative depth map image according to any of Embodiments 1-4.

Embodiment 15. A computer program product comprising a program code stored on a computer readable media for executing the method (10) for training a neural network to generate a relative depth map image according to any of Embodiments 1-4.

Embodiment 16. A computer program comprising computer program code for executing the method (20) for generating a relative depth map image according to any of Embodiments 5-11.

Embodiment 17. A computer program product comprising a program code stored on a computer readable media for executing the method (20) for generating a relative depth map image according to any of Embodiments 5-11.

What is claimed is:

1. A method for training a neural network to generate a relative depth map image, the method comprising:
obtaining a first set of images relating to a region of interest within a first time period;
obtaining a second set of images relating to the region of interest within a second time period;
generating a first depth map image based on the first set of images, the first depth map image relating to a depth of the region of interest when observed at a certain attitude and position with respect to the region of interest;
generating a second depth map image based on the second set of images, the second depth map image relating to a depth of the region of interest when observed at the corresponding attitude and position with respect to the region of interest as the first depth map image;
generating a first relative depth map image based on a difference between the first depth map image and the second depth map image;
generating, using the neural network, a second relative depth map image, based on a first input image comprising at least one of: the first depth map image, an image of the first set of images, an image generated from a 3D-model of the region of interest at the first time period, and a second input image comprising at least one of: an image of the second set of images, an image generated from a 3D-model of the region of interest at the second time period, wherein the first input image and the second input image have the corresponding attitude and position with respect to the region of interest; and
changing parameters of the neural network based on a difference between the second relative depth map image and the first relative depth map image.

2. The method according to claim 1, wherein generating the first depth map image further comprises:
generating a first 3D-model of the region of interest at the first time period based on the first set of images, and wherein generating the first depth map image is further based on the first 3D-model.

3. The method according to claim 1, wherein generating the second depth map image further comprises:
generating a second 3D-model of the region of interest at the second time period based on the second set of images, and wherein generating the second depth map image is further based on the second 3D-model.

4. The method according to claim 1, wherein the first and second sets of images relating to the region of interest comprise satellite images and/or panchromatic images and/or synthetic aperture radar, SAR, images and/or aerial images.

5. A method for generating a relative depth map image, the method comprising:
obtaining a first input image relating to a region of interest observed at a first time period and at a specific attitude and position relative to the region of interest, the first input image comprising at least one of: a first depth map image of the region of interest when observed at said attitude, position and first time period, an image of the region of interest when observed at said attitude, position and first time period, an image generated from a 3D-model of the region of interest at the first time period, the image generated from the 3D-model being generated at said attitude and position with respect to the region of interest;
obtaining a second input image relating to the region of interest observed at a second time period and at the corresponding attitude and position relative to the region of interest as for the first input image, the second input image comprising at least one of: an image of the region of interest when observed at said attitude, position and second time period, an image generated from a 3D-model of the region of interest at the second time period, the image generated from the 3D-model being generated at said attitude and position with respect to the region of interest; and
generating, using a neural network, the relative depth map image, based on the obtained first and second input images.

6. The method according to claim 5, further comprising:
generating a second depth map image based on the first depth map image and the generated relative depth image.

7. The method according to claim 5, further comprising:
detecting if the generated relative depth image meets a predetermined criterion relating to a measure of change of relative depth.

8. The method according to claim 5, further comprising:
determining a volumetric change based on a plurality of generated relative depth images of the region of interest at different respective attitudes and positions with respect to the region of interest.

9. The method according to claim 5, further comprising:
determining characteristics of zones in the generated relative depth image, wherein the characteristics of a zone comprise at least one of: identification of a zone comprising an infrastructure project, identification of a zone with a completed or non-completed building construction and/or building tear-down, identification of a zone being an agricultural field from identification of seasonal changes, identification of a zone of deforestation, identification of a zone comprising melting ice, such as a glacier, identification of a zone comprising a land slide, identification of a zone affected by an earth quake, identification of a zone affected by fire, identification of a zone affected by flooding, identification of a zone comprising at least one vehicle.

10. The method according to claim 5, further comprising:
determining if a predetermined trigger level for triggering reconstruction of a 3D-model of the region of interest is exceeded based on at least one generated relative depth image.

11. The method according claim 5, wherein the first and/or second input image comprises satellite images and/or panchromatic images and/or synthetic aperture radar, SAR, images and/or aerial images.

12. A system for generating a relative depth map image, the system comprising processing circuitry configured to:
obtain a first input image relating to a region of interest observed at a first time period and at a specific attitude and position relative to the region of interest, the first input image comprising at least one of: a first depth map image of the region of interest when observed at said attitude, position and first time period, an image of the region of interest when observed at said attitude, position and first time period, an image generated from a 3D-model of the region of interest at the first time period, the image generated from the 3D-model being generated at said attitude and position with respect to the region of interest;
obtain a second input image relating to the region of interest observed at a second time period and at the corresponding attitude and position relative to the region of interest as for the first input image, the second input image comprising at least one of: an image of the region of interest when observed at said attitude, position and second time period, an image generated from a 3D-model of the region of interest at the second time period, the image generated from the 3D-model being generated at said attitude and position with respect to the region of interest; and
generate, using a neural network, the relative depth map image, based on the obtained first and second input images.

13. The system according to claim 12, wherein the processing circuitry comprises a processor and a memory, wherein the memory comprises instructions executable by said processor.
